(19) United States
(12) Patent Application Publication
(10) Pub. No.: US 2026/0109510 A1
(43) Pub. Date: Apr. 23, 2026

(54) RECYCLABLE AND SUSTAINABLE APPARATUS AND METHOD FOR PACKAGING PRODUCTS

(71) Applicant: THE GARDNER GROUP, LLC, Springfield, MO (US)

(72) Inventors: Randal D. Olson, Lakeland, MN (US); Joel R. Olson, Menomonie, WI (US); Kevin W Cyr, Minneapolis, MN (US)

(21) Appl. No.: 19/476,822

(22) PCT Filed: May 3, 2024
(86) PCT No.: PCT/US2024/027833

§ 371 Date: Oct. 20, 2025

Related U.S. Application Data
(60) Provisional application No. 63/464,146, filed on May 4, 2023.

(51) Int. Cl. B65D 5/50; B32B 1/00; B32B 3/28; B32B 7/12; B32B 29/00; B32B 29/08; B65D 65/40

(52) U.S. Cl. CPC B65D 5/5057; B32B 1/00; B32B 3/28; B32B 7/12; B32B 29/005; B32B 29/08; B65D 65/403; B32B 2250/05; B32B 2250/26; B32B 2439/00

(57) ABSTRACT

A product support constructed, at least in part, from interlocked corrugated elements that are largely fabricated from corrugated fiberboard and other recyclable and sustainable materials is disclosed herein. Two or more cormgated elements are interlocked to form the product support that includes a package receiving cavity shaped to receive and support a product in a container. The product support defines engagement surfaces to engage the inner walls of the container.

### CROSS-REFERENCE TO RELATED APPLICATIONS

This application claims priority and benefit of U.S. Provisional Ser. No. 63/464,146 filed May 4, 2023, which is hereby incorporated by reference in its entirety herein.

### BACKGROUND OF THE INVENTION

### Field of the Invention

The present inventions relate to the packaging of products for shipment and, more particularly, to packaging materials made from corrugated fiberboard to secure products in containers including boxes, crates, and other packaging.

### Background of the Related Art

Packaging materials, in various forms, have been an important part of shipping products since products were boxed and shipped. Such packaging materials generally include a container and internal packaging materials to secure the product within the container. As used herein, container may include, for example, various crates, containers, cartons, boxes, cases, and other exterior packaging of various shapes and sizes as may be used in the shipment of products. Product may include, for example, various goods, manufactures, apparatuses, objects, commodities as may be shipped within the container. Internal packaging materials are generally designed to conform to various aspects of the product and engage the product in a manner that secures the product within the container. The internal packaging may be designed to protect the product from damage resulting from impacts to, bending of, or penetration of the container. The internal packaging materials may do this by supporting and/or suspending the product within the container. For example, the internal packaging materials may be configured and placed at each end of the container to support the product in suspension within the container in such a manner that the product is disposed away from direct contact with the inner walls of the container. This may protect the product from shocks or may distance the product from damage done to the outer wall of the container.

Some currently available internal packaging materials are petroleum-based materials including various plastics and foams such as polyethylene foams, polyether foams, polyester foams, polyurethane foams, and polyimide foams. Such internal packaging materials represent a huge volume of petroleum-based material that is produced every year that is not biodegradable and does not help in attaining sustainability goals.

Furthermore, the petroleum-based foam packing materials are generally not recyclable and take up a tremendous volume of space in landfills. Once discarded, these foam packaging materials slowly break down into smaller and smaller particles that are carried by wind and water away from the location where they were discarded. These particles may work their way into the food chain and add to the huge volumes of microplastics contaminating our planet and negatively impacting the biological systems of all creatures. Therefore, a need exists for packaging materials that are not only recyclable, but are easily biodegradable when disposed of in landfills.

Foam packaging may also be delicate and easily broken when packaging products before even being distributed to the consumer. The broken foam packaging frequently goes unused by the manufacturer and is discarded. Such wasted packaging may increase the costs of packaging manufactured goods. This unused packaging further increases the volume of waste foams that are discarded, tax our landfills, and damage the environment. Thus, a more robust packaging material that is more resistant to breakage during the packaging process would be advantageous to both manufacturers and to the environment.

Furthermore, although many of these petroleum-based materials are recyclable, in actual practice, only a small fraction of this material enter into the recycling process. Of the small fraction entering the “recycling” system, a large volume of the plastic is mixed and practically inseparable and is placed into the vast world-wide stores of regrind that is generally considered commercially unusable. Therefore, a need exists for internal packaging materials that are not merely recyclable in theory but in fact are actually recycled and reused.

Other internal packaging materials include paperboard inserts utilized to secure products within containers that are formed of cellulose based materials. However, these paperboard inserts may be weak, complicated, time consuming, and, thus, expensive, to use for packaging. With heavy products, such paperboard internal packaging materials may be insufficient and tend to fail when placed in the stream of commerce so that polymeric foam discussed above is typically used for heavier products. In use, paperboard internal packaging materials are typically cut and folded to receive and secure the product within a container. The time and effort to package products with such paperboard inserts may increase the costs to the manufacturer that are passed through to consumers. Therefore, a need exists for a more robust, simpler system that may increase the efficiency of the packaging process while supporting heavier products.

Corrugated fiberboard is the most highly recycled material on earth and has extraordinary strength. Corrugated fiberboard is cellulose based and typically uses starch-based adhesives. Thus, even if corrugated fiberboard is not recycled, corrugated fiberboard is readily biodegradable. Furthermore, corrugated fiberboard is a very strong material, particularly under compression along the axes of its flutes. However, corrugated fiberboard has limited flexibility for use in applications requiring folding. Corrugated fiberboard may not only be difficult to fold, but corrugated fiberboard may have a tendency to revert to its original unfolded state that may make the packaging process more difficult. Furthermore, the structural integrity of corrugated fiberboard may be compromised by the folding process, by tearing of the linerboards and/or the collapsing of the flutes, among other things, when folded. Accordingly, a need exists for packaging systems that may utilize the strength of corrugated fiberboard in packaging applications that are easily implemented and improve the utilization of corrugated fiberboards inherent strength and environmental impact.

To further improve sustainability by minimize the amount of corrugated fiberboard used in packaging applications, designs that optimize the inherent strength of the corrugated fiberboard are needed. Such strength is critical in packaging and shipping heavy items. Generally, corrugated fiberboard has a relatively high level of compressional strength. This strength may be enhanced by laminated multiple layers of corrugated fiberboard. The strength of corrugated fiberboard is particularly high along the axis of its flutes. However, the cost of corrugated fiberboard packaging may be prohibitive. Accordingly, a need exists for packaging designs that may maximize strength while reducing the amount of corrugated fiberboard required in packaging applications while improving the sustainability of corrugated fiberboard packaging.

### BRIEF SUMMARY OF THE INVENTION

These and other needs and disadvantages may be overcome by the apparatus and related methods disclosed herein. Additional improvements and advantages may be recognized by those of ordinary skill in the art upon study of the present disclosure.

Apparatus in accordance with aspects of the present inventions may be configured as a product support used to support a product in packaging. The product support may include a first corrugated element and a second corrugated element secured to one another at right angles to one another.

In various aspects, the first corrugated element defines a first peripheral edge, a front side and a back side. The first corrugated element includes a plurality of laminated layers of corrugated fiberboard. The plurality of layers of corrugated fiberboard are laminated together with an adhesive between linerboards of the plurality of layers of corrugated fiberboard. The front side of the first corrugated element defining a first front plane and the back side of the first corrugated element defines a first back plane. The first front plane and the first back plane oriented in parallel. The first peripheral edge has at least one first engagement portion to contact at least an inner wall of a container. The first corrugated element also defines at least one interlocking passage extending between the front side and a back side of the first corrugated element.

In various aspects, the second corrugated element defines a second peripheral edge, a second front side and a second back side. The second corrugated element includes a plurality of corrugated fiberboard sheets laminated with the adhesive between the linerboards of the plurality of corrugated fiberboard sheets. The second front side of the second corrugated element defines a second front plane and the second back side defining a second back plane. The second front plane and the second back plane oriented in parallel. The second peripheral edge has at least one second engagement portion to contact the inner wall of the container. The second peripheral edge of the second corrugated element further defines at least one interlocking protuberance. The at least one interlocking protuberance of the second corrugated element is received within the at least one interlocking passage of the first corrugated element to secure the first corrugated element to the second corrugated element. The front side and the back side of the first corrugated element is secured perpendicular to the second front side and the second back side of the second corrugated element. At least one of the first corrugated element and the second corrugated element define at least in part a product receiving cavity configured to receive at least a portion of a product and to secure the product relative to the container and the first engagement portion of the first peripheral edge of the first corrugated element and the second engagement portion of the second peripheral edge of the second corrugated element relatively positioned to abut at least one inner wall of a container.

In various aspects, a third corrugated element defining a third peripheral edge, a third front side and a third back side, the first corrugated element may also be provided. The third corrugated element is formed from a plurality of corrugated fiberboard sheets. The plurality of layers of corrugated fiberboard sheets laminated with an adhesive between linerboards of the plurality of corrugated fiberboard sheets. The third corrugated element has a third front side defining a third front plane and the third back side defining a third back plane. The third front plane and the third back plane oriented in parallel, the third peripheral edge having at least one third engagement portion to contact at least an inner wall of a container. The third corrugated element defining at least one of a third interlocking passage extending between the third front side and a third back side of the third corrugated element and third interlocking protuberance. The third corrugated element may be secured to the first corrugated element, when a third interlocking protuberance is provided, by securing the third interlocking protuberance through a second first interlocking passage in the first corrugated element or, when a third interlocking passage is provided, receiving a second second interlocking protuberance formed in the second corrugated element.

This summary is presented to provide a basic understanding of some aspects of the apparatus and methods disclosed herein as a prelude to the detailed description that follows below. Accordingly, this summary is not intended to identify key elements of the apparatus and methods disclosed herein or to delineate the scope thereof.

### BRIEF DESCRIPTION OF THE DRAWINGS

FIG. 1A illustrates by perspective view an exemplary implementation of a product support in accordance with aspects of the present inventions;

FIG. 1B illustrates by frontal view an exemplary first corrugated element of the exemplary product support of FIG. 1A in accordance with aspects of the present inventions;

FIG. 1C illustrates by top view an exemplary second corrugated element of the exemplary product support of FIG. 1A in accordance with aspects of the present inventions;

FIG. 1D illustrates by frontal view the exemplary product support of FIG. 1A in accordance with aspects of the present inventions;

FIG. 1E illustrates by top view the exemplary product support of FIG. 1A in accordance with aspects of the present inventions;

FIG. 1F illustrates by side view the exemplary product support of FIG. 1A in accordance with aspects of the present inventions;

FIG. 2A illustrates by perspective view a second exemplary implementation of a product support in accordance with aspects of the present inventions;

FIG. 2B illustrates by frontal view an exemplary first corrugated element of the second exemplary implementation of a product support of FIG. 2A in accordance with aspects of the present inventions;

FIG. 2C illustrates by top view an exemplary second corrugated element of the second exemplary implementation of a product support of FIG. 2A in accordance with aspects of the present inventions;

FIG. 2D illustrates by exploded view the second exemplary implementation of a product support of FIG. 2A in accordance with aspects of the present inventions;

FIG. 3A illustrates by perspective view a third exemplary implementation of a product support in accordance with aspects of the present inventions;

FIG. 3B illustrates by top view an exemplary second corrugated element of the third exemplary implementation of a product support of FIG. 3A in accordance with aspects of the present inventions;

FIG. 3C illustrates by frontal view an exemplary first corrugated element of the third exemplary implementation of a product support of FIG. 3A in accordance with aspects of the present inventions;

FIG. 4A illustrates by perspective view a fourth exemplary implementation of a product support in accordance with aspects of the present inventions;

FIG. 4B illustrates by side view an exemplary second corrugated element of the fourth exemplary implementation of a product support of FIG. 4A in accordance with aspects of the present inventions;

FIG. 4C illustrates by side view an exemplary third corrugated element of the fourth exemplary implementation of a product support of FIG. 4A in accordance with aspects of the present inventions;

FIG. 4D illustrates by frontal view the exemplary second corrugated element of the fourth exemplary implementation of a product support of FIG. 4A in accordance with aspects of the present inventions;

FIG. 5A illustrates an exploded perspective view of an exemplary implementation of a packaging system including a product, product supports, and a container in accordance with aspects of the present inventions;

FIG. 5B illustrates by perspective view the exemplary packaging system of FIG. 5A in accordance with aspects of the present inventions including a product in cooperation with product supports disposed within the container;

FIG. 5C illustrates by perspective view an exemplary container top of the exemplary container of FIG. 5A;

FIG. 5D illustrates by top view the exemplary container of FIG. 5A with the container top removed;

FIG. 6A illustrates by perspective view an exemplary implementation of a single wall corrugated fiberboard as may be comprised by the exemplary product supports of FIGS. 1A, 2A, 3A, 4A;

FIG. 6B illustrates by perspective view an exemplary implementation of a double wall corrugated fiberboard as may be comprised by the exemplary product supports of FIGS. 1A, 2A, 3A, 4A;

FIG. 6C illustrates by perspective view an exemplary implementation of a triple wall corrugated fiberboard as may be comprised by the exemplary product supports of FIGS. 1A, 2A, 3A, 4A;

FIG. 6D illustrates by end view the exemplary single wall corrugated fiberboard of FIG. 6A; and

FIG. 7 illustrates by end view an exemplary laminate comprising two single wall corrugated fiberboard sheets laminated together as may be comprised by the exemplary product supports of FIGS. 1A, 2A, 3A, 4A in accordance with aspects of the present inventions.

The Figures are exemplary only and the implementations illustrated therein are selected to facilitate explanation of various aspects of the present inventions. The number, position, relationship and dimensions of the elements shown in the Figures to form the various implementations described herein, as well as dimensions and dimensional proportions to conform to specific force, weight, strength, flow and similar requirements are either explained herein or are understandable to a person of ordinary skill in the art upon study of this disclosure. Where used in the various Figures, the same numerals designate the same or similar elements. Furthermore, when the terms “top,” “bottom,” “right,” “left,” “front,” “back,” “first,” “second,” “inside,” “outside,” and similar terms are used, the terms should be understood in reference to the orientation of the implementations shown in the drawings and are utilized to facilitate description thereof. Use herein of relative terms such as generally, about, approximately, essentially, may be indicative of engineering, manufacturing, or scientific tolerances such as ±0.1%, ±1%, ±2.5%, ±5%, or other such tolerances, as would be recognized by those of ordinary skill in the art upon study of this disclosure.

### DETAILED DESCRIPTION OF THE INVENTION

The Figures generally illustrate exemplary implementations of product support 10 comprised of corrugated fiberboard for use in packaging products 500 for shipping and/or sale to customers that include aspects of their configuration, manufacture and assembly in accordance with the present inventions. The particularly illustrated implementations of product support 10 have been chosen for ease of explanation and understanding of various aspects of the present inventions. It will be understood that the term product support shall include other similar products used for securing goods packaged in containers that may use the product support 10 or other structurally similar apparatus for packaging goods in accordance with of the present teachings. That said, the illustrated implementations are not meant to limit the scope of coverage but, instead, to assist in understanding the context of the language used in this specification and in the appended claims. Accordingly, the appended claims may encompass variations of product supports 10 and similar packing components that differ from the illustrated implementations.

The present inventions provide apparatus for the packaging of products 500 in containers, such as container 200, to support and protect the packaged products 500 during shipment, storage, display and/or consumer transport. The product supports 10 disclosed herein are predominately manufactured from corrugated fiberboard 140. Corrugated fiberboard 140 is recyclable and represents one of the most recycled materials in the world. Product supports 10 made with corrugated fiberboard 140 may provide a more sustainable solution for packaging supports than the hard plastics or petroleum based polymeric foams that are typically used. As used herein, the sheets of corrugated fiberboard 140 are laminated together with an adhesive 110 to form laminate 100 but additional materials may be included in layers of the laminate 100.

Exemplary product supports 10 as well as exemplary component thereof are illustrated in the Figures. As illustrated, product supports 10 are generally configured to support one or more products 500 within container 200. Note that exemplary container 200 illustrated as having a rectangular box configuration is presented for purposes of explanation and is not limiting. Accordingly, product support 10 may be adapted for other configurations of container 200, in various other implementations. Generally, two or more product supports 10 may be utilized in coordination to support products 500 within container 200. When two product supports 10 are utilized, the product supports 10 may be secured at opposite sides or ends of the product 500 or at the top and bottom of the product 500. Further, the product supports 10 may be designed to support single or multiple items to be packaged in a single container 200.

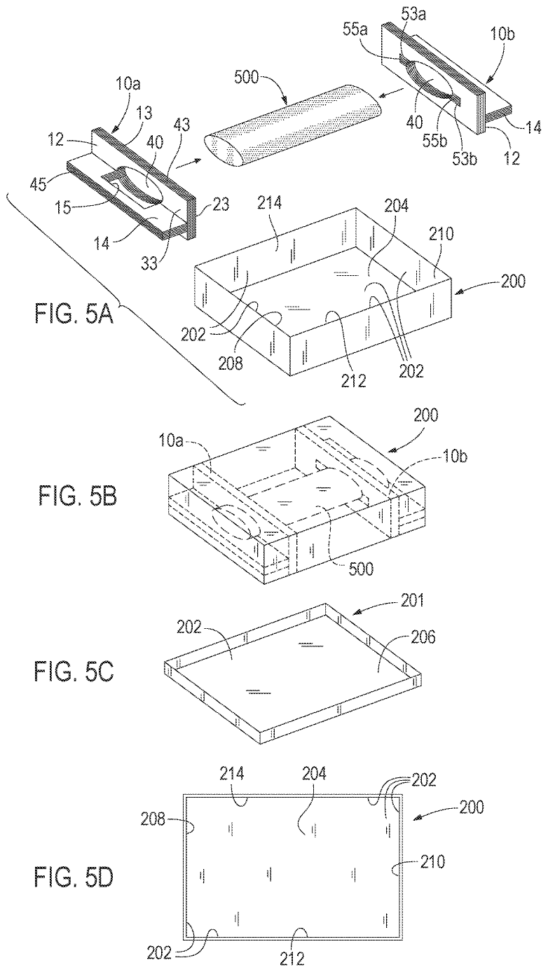

For example, product supports 10 may be generally configured to support product 500 in gapped relation with at least one of the inner walls 202 of container 200 (see FIGS. 5A-5D) by abutting in biased engagement one or more of the inner walls 202. As illustrated, inner walls 202 include bottom inner wall 204, top inner wall 206, left inner wall 208, right inner wall 210, front inner wall 212, and back inner wall 214. For example, an individual product support 10 may be configured to: only abut bottom inner wall 204; abut bottom inner wall 204 and left inner wall 208, abut bottom inner wall 204, left inner wall 208, and front inner wall 212; abut bottom inner wall 204, the left inner wall 208, front inner wall 212, and back inner wall 214; abut bottom inner wall 204, left inner wall 208, front inner wall 212, back inner wall 214, and top inner wall 206.

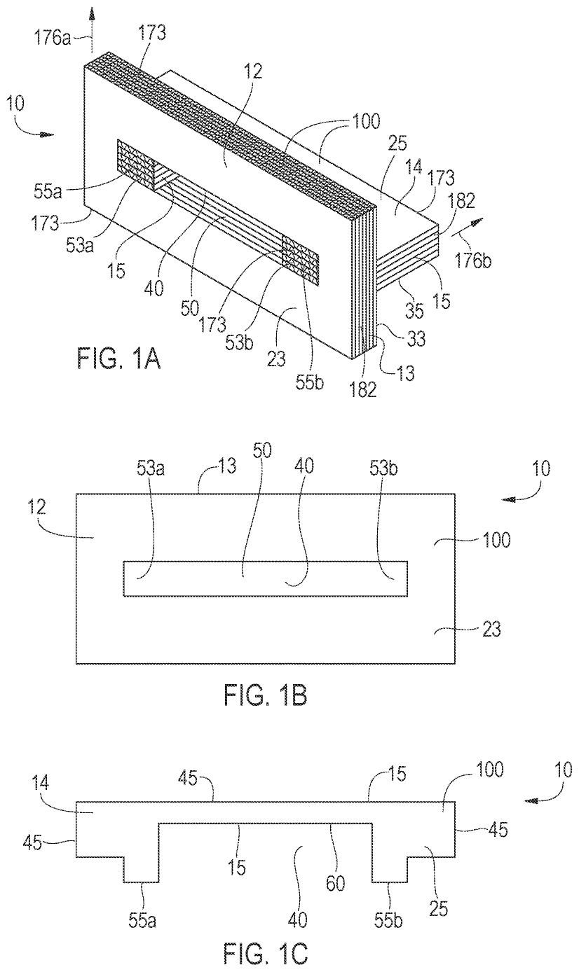

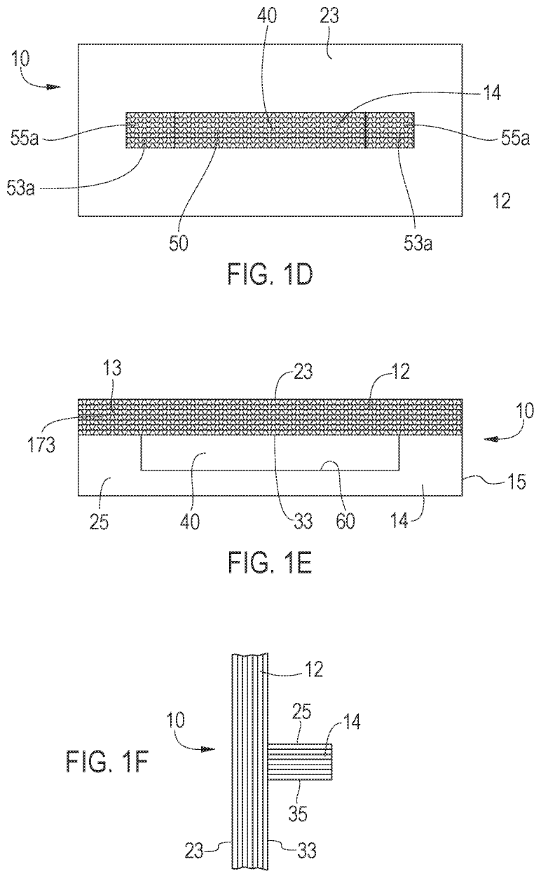

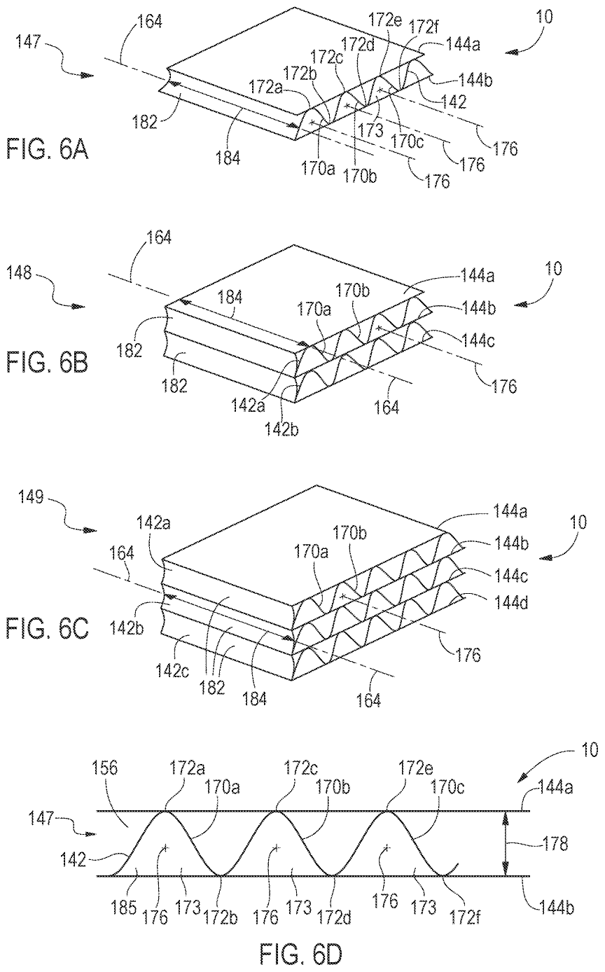

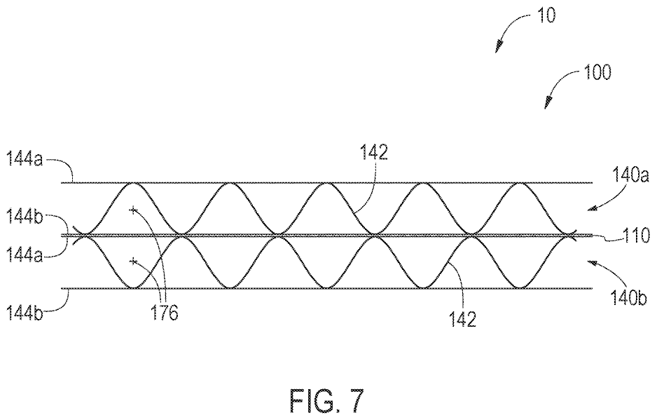

As illustrated, product supports 10 are generally constructed from a first corrugated element 12 and a second corrugated element 14. Each of these corrugated elements 12, 14 is made from laminate 100 of corrugated fiberboards 140, in this implementation. Note that first front side 23 and first back side 33 of first corrugated element 12 each have a planar configuration and are aligned parallel to one another, in this implementation. Similarly, second front side 25 and second back side 35 of second corrugated element 14 each have a planar configuration and are aligned parallel to one another, in this implementation. The layers of corrugated fiberboard 140 in laminations 100 that form each corrugated element 12, 14 may have the flute axes 176 (also see FIGS. 6A-6D, 7) oriented parallel to one another. Columns 182 and open ends 173 of flutes 170 of the corrugated fiberboards 140 that comprise laminations 100 are indicated in FIG. 1A. When assembled, the flute axes 176a of the first corrugated element 12 may be oriented at a right angle to the flute axes 176b of the second corrugated element 14 to maximize the strength of product support 10 in order to support product 500 within container 200, support container 200 by contacting the inner walls 202 of container 200, or both support product 500 within container 200 and support inner walls 202 of container 200. Because the flute axes 176a of the first corrugated element 12 are oriented at a right angle to the flute axes 176b of the second corrugated element 14, the load bearing axes 164 (see FIGS. 6A-6C) of first corrugated element 12 and second corrugated element 14 are perpendicular to one another, in such implementations. The corrugated elements 12,14 are secured to one another by an interlocking protuberance(s) 55a, 55b on one corrugated element 12,14 being received in an interlocking passage(s) 53a, 53b in the other corrugated element 12,14. The interlocking protuberance(s) 55a, 55b are typically secured by being compressionally engaged or adhesively secured within the interlocking passage(s) 53a, 53b to prevent separation of corrugated elements 12, 14, for example, during the packaging process, during warehousing, or during shipment.

The product support 10 defines a product receiving cavity 40 to receive and secure or support a portion of product 500. The product receiving cavity 40 for purposes of this disclosure may be a cavity, channel, passage, recess, product conforming surface or other supportive or retaining structure of product support 10 that in combination with other product supports 10 used to package the product 500 support and/or secure the product 500 in a desired position within container 200. Thus, in certain implementations, product receiving cavity 40 may be generally sized to receive and support a portion of product 500 and may define a shape that conforms to the portions of product 500 so received.

An implementation of product support 10 is illustrated in FIGS. 1A to 1F. As illustrated, product support 10 is formed from a first corrugated element 12 and a second corrugated element 14 secured to one another by a pair of interlocking protuberances 55a and 55b securely received within interlocking passages 53a and 53b. As illustrated, the interlocking passages 53a, 53b are coincident with portions of the product receiving cavity 40 defined by the first corrugated element 12. Second corrugated element 14 defines a pair of interlocking protuberances 55a and 55b, as illustrated. The pair of interlocking protuberances 55a, 55b are sized and shaped to be securably received in the corresponding interlocking passages 53a, 53b defined by the lateral portions of the product receiving cavity 40. in other implementations, interlocking passages 53a, 53b may be separable from product receiving cavity 40. In yet other implementations, interlocking passages 53a, 53b may pass through second corrugated element 14 between second front side 25 and second back side 35 that engage corresponding interlocking protuberances 55a, 55b of first corrugated element 12 to secure first corrugated element 12 and second corrugated element 14 to one another. That is, in various implementations, interlocking passages, such as interlocking passages 53a, 53b, and interlocking protuberances, such as interlocking protuberances 55a, 55b, may be variously disposed about first corrugated element 12 and second corrugated element 14 that cooperate in order to secure first corrugated element 12 and second corrugated element 14 together.

The product receiving cavity 40 is peripherally defined by the walls of passage 50 cut through the first corrugated element 12 between first front side 23 and first back side 33, in this implementation. Passage 50 may be formed by die cutting, in various implementations. Passage 50 is shown in the shape of a rectangle for explanatory purposes, but passage 50 may assume any desired shape, in other implementations. For example, receiving cavity 40 may be shaped to securedly receive an end of product 500 and support product 500 by, at least in part, peripherally conforming to an exterior shape of the end of the product 500. A portion of the second peripheral edge 15 of the second corrugated element 14, when received in the interlocking passages 53a, 53b, defines a cavity end portion 60 of the product receiving cavity 40 shaped to contact and support an end surface of a product 500. Thus, the product receiving cavity 40 may have a cross-sectional shape corresponding cross-sectional and end shape of a product 500 to secure the product 500 in a desired position within container 200.

To secure product supports 10 within container 200, the first peripheral edge 13 of the product support 10 is configured to be peripherally in contact with the inner walls 202 of container 200. Thus, in the illustrated implementations, the first peripheral edge 13 is configured to function as a first engagement portion 43 to contact an entire internal rectangular cross section of container 200 including front inner wall 212, bottom inner wall 204, back inner wall 214, and top inner wall 206 (see FIG. 5A). A portion of the second peripheral edge 15 includes a second engagement portion 45. The second engagement portion 45, as illustrated, includes a portion to extend across the depth of container 200 along either left inner wall 208 (e.g., product support 10a in FIG. 5A) or right inner wall 210 (e.g., product support 10b in FIG. 5A) and second engagement portions 45 to contact a length of the front inner wall 212 and a length of the back inner wall 214. With product supports 10a, 10b each positioned at an end of container 200 and a product 500 received in and abutting the portion of the second peripheral edge 15 of the second corrugated element 14 that defines the end of the product receiving cavity 40, product 500 may be securely suspended within container 200 and may be thus suspended in spaced relation with inner walls 202.

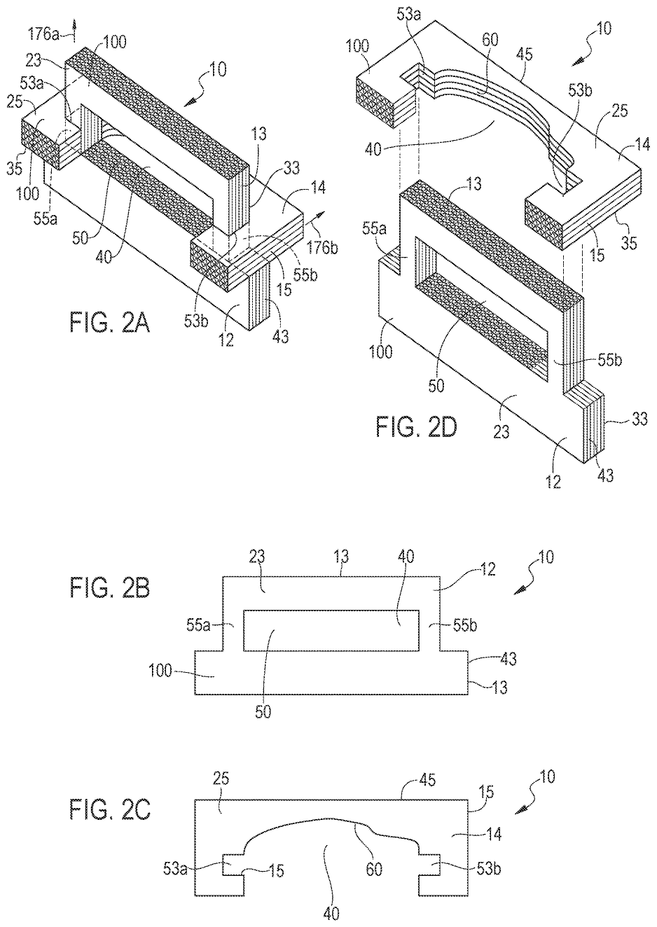

Another implementation of the present invention is illustrated in FIGS. 2A to 2D. As illustrated, product support 10 is formed from a first corrugated element 12 and a second corrugated element 14. Each of these corrugated elements 12, 14 is made from laminate 100 of corrugated fiberboards 140, in this implementation. Flute axes 176a, 176b of first corrugated element 12 and second corrugated element 14, respectively, are oriented perpendicular to one another, as illustrated, so that load bearing axes 164 (see FIGS. 6A-6C) of first corrugated element 12 and second corrugated element 14 are perpendicular to one another. As illustrated, first corrugated element 12 defines a pair of interlocking protuberances 55a, 55b, and a pair of interlocking passages 53a, 53b are defined by portions of the second peripheral edge 15 of the second corrugated element 14. First corrugated element 12 and second corrugated element 14 are secured to one another by interlocking protuberances 55a and 55b of element 12 being secured within interlocking passages 53a and 53b of corrugated element 14. Thus, each of the interlocking protuberances 55a, 55b is sized and shaped to be securablv received in the corresponding interlocking passages 53a, 53b to secure the first corrugated element 12 to the second corrugated element 14, in this implementation.

The product receiving cavity 40 of exemplary product support 10 illustrated in FIGS. 2A-2D is peripherally defined by the walls of a passage 50 cut through the first corrugated element 12 between first front side 23 and first back side 33 and by portions of second peripheral edge 15 of corrugated element 14. Again, passage 50 is shown in the shape of a rectangle for explanatory purposes. Passage 50 may be shaped to securedly receive an end of product 500 by at least in part peripherally conforming to an exterior shape of the end of product 500, in various implementations. When first corrugated element 12 and a second corrugated element 14 are secured to one another, the resultant product receiving cavity 40 has a cross sectional shape to securedly receive product 500 having a corresponding cross-sectional shape. The interlocking passages 53a, 53b are defined laterally by portions of the second peripheral edge 15 of the second corrugated element 14. Unlike the implementation illustrated in FIGS. 1A to 1F, the cavity end portion 60 of the product receiving cavity 40 defined by portions of the second peripheral edge 15 of second corrugated element 14 is illustrated as an irregular shape that conforms to a correspondingly irregularly shaped end of an exemplary product 500 to be conformably received within the product receiving cavity 40. Note that interlocking protuberances 55a, 55b engaged with interlocking passages 53a, 53b define portions of the product receiving cavity 40, in this implementation.

The first peripheral edge 13 of first corrugated element 12 is configured to contact the inner walls 202 of container 200 around at least portions of its periphery. Thus, in the illustrated implementations, the first peripheral edge 13 is configured to function as a first engagement portion 43 to contact inner walls 202 at most of the internal rectangular cross section of container 200 including the entirety of the depth of bottom inner wall 204, a majority of the top inner wall 206, and, for illustrative purposes, about ⅓ of both the front inner wall 212 and the back inner wall 214. A portion of the second peripheral edge 15 includes a second engagement portion 45. The second engagement portion 45, as illustrated, includes a portion to extend across the depth of container 200 along either left inner wall 208 or right inner wall 210 and second engagement portions 45 to contact a length of the front inner wall 212 and a length of back inner wall 214. With two product supports 10 positioned at each end of container 200 and a product 500 received in and abutting the portion of the second peripheral edge 15 of the second corrugated element 14 that defines the end of the product receiving cavity 40, a product 500 may be securely suspended within container 200.

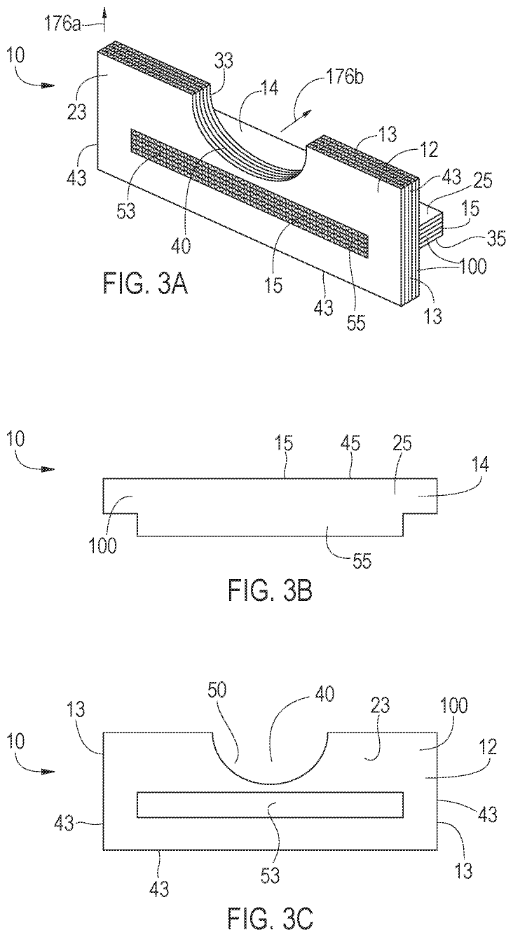

Another implementation of product support 10 is illustrated in FIGS. 3A to 3C. As illustrated, product support 10 is formed from a first corrugated element 12 and a second corrugated element 14. Each of these corrugated elements 12, 14 is made from laminate 100 of corrugated fiberboards 140, in this implementation. The product receiving cavity 40 is defined as a semi-circular cavity along the top portion of the first peripheral edge 13 of the first corrugated element 12. The product receiving cavity 40 has a circular cross section to receive a product 500 with a cylindrical cross section along the portion of the product 500 that is received in product receiving cavity 40. The interlocking passage 53 is an elongated rectangular passage extending from the first front side 23 to the first back side 33 of first corrugated element 12 that may be formed by die cutting. Second corrugated element 14 defines an interlocking protuberance 55. The interlocking protuberance 55 is sized and rectangularly shaped in cross-section to be securably received within the interlocking passage 53 extending through first corrugated element 12. For example, each corrugated fiberboard is die cut to form either a portion of an interlocking protuberance or a portion of an interlocking passage before lamination into laminate 100 configured as either first corrugated element 12 or second corrugated element 14.

The first peripheral edge 13 is configured to have only its sides and its bottom portion function as first engagement portion 43 and be peripherally in contact with the inner walls 202 of container 200. Thus, in the illustrated implementations, the first peripheral edge 13 is configured to function as a first engagement portion 43 to contact only a portion of the internal rectangular cross section of container 200 including the front inner wall 212, bottom inner wall 204, back inner wall 214 and top inner wall 206. A portion of the second peripheral edge 15 includes a second engagement portion 45. The second engagement portion 45, as illustrated, includes a portion to extend across the depth of container 200 along either left inner wall 208 or right inner wall 210 and second engagement portions 45 to contact a length of front inner wall 212 and a length of back inner wall 214. With two such product supports 10 one positioned at each end of container 200 and product 500 received in and abutting left inner wall 208 and right inner wall 210 of container 200, product 500 may be suspended within container 200. However, product 500 would be not be maintained in position if container 200 were inverted. In some applications this is an acceptable configuration. However, a second pair of product supports 10 of the same configuration illustrated in FIGS. 3A-3C may be inverted and placed upside down over the top of the cylindrical product 500 to juxtapose the semi-circular product receiving cavities 40 over the lower semi-circular product receiving cavities to securably hold the cylindrical product 500 in position within container 200 regardless of the orientation of container 200.

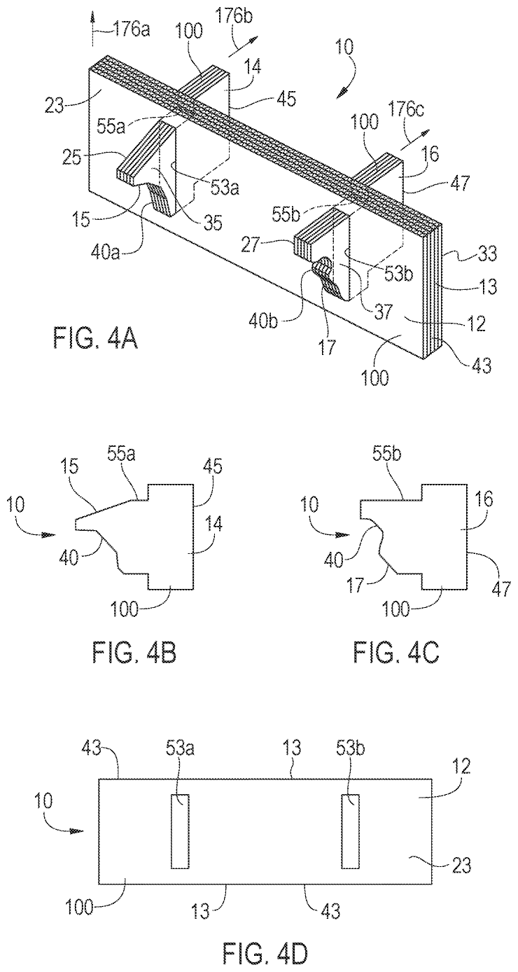

Another implementation of the present invention is illustrated in FIGS. 4A to 4D. As illustrated, the product support 10 is formed from a first corrugated element 12, a second corrugated element 14, and a third corrugated element 16. Third front side 27 and third back side 37 of third corrugated element 16 each have a planar configuration and are aligned parallel to one another, as illustrated. Each of these corrugated elements 12, 14, 16 is made from laminate 100 of corrugated fiberboards 140, in this implementation. Flute axes 176b, 176c of second corrugated element 14 and third corrugated element 16, respectively, are parallel to one another and perpendicular to flute axes 176a of first corrugated element 12, as illustrated, when second corrugated element 14 and third corrugated element 16 are secured to first corrugated element 12. The product receiving cavity 40 is peripherally defined by the walls of a rectangular passage cut through the first corrugated element 12 between its first front side 23 and the first back side 33. The product receiving cavities 40a and 40b are defined by the second peripheral edge 15 and the third peripheral edge 17 of the second corrugated element 14 and the third corrugated element 16, respectively. The interlocking passages 53a, 53b, which may be formed by die cutting, are vertically-oriented and spaced apart to receive second corrugated element 14 and a third corrugated element 16, respectively. Second corrugated element 14 defines an interlocking protuberance 55a and third corrugated element 16 defines an interlocking protuberance 55b. Each interlocking protuberance 55a, 55b is sized and shaped to be securely received within the interlocking passages 53a, 53b, respectively. The first peripheral edge 13 is configured to be peripherally in contact with the inner walls 202 of container 200. Thus, in the illustrated implementations, the first peripheral edge 13 is configured to function as a first engagement portion 43 to contact entire internal rectangular cross section of container 200 including the front inner wall 212, bottom inner wall 204, back inner wall 214 and top inner wall 206. A portion of the second peripheral edge 15 includes a second engagement portion 45. The second engagement portion 45, as illustrated, includes a portion to extend across the depth of container 200 along either left inner wall 208 or right inner wall 210 and second engagement portions 45 to contact a length of the front inner wall 212 and a length of back inner wall 214. A portion of the third peripheral edge 17 includes a third engagement portion 47. The third engagement portion 47, as illustrated, includes a portion to extend across the depth of container 200 along either left inner wall 208 or right inner wall 210 and third engagement portions 47 to contact a length of the front inner wall 212 and a length of back inner wall 214. With two product supports 10 positioned at each end of container 200 and a product 500 received in and abutting the portion of the second peripheral edge 15 of the second corrugated element 14 that defines the end of the product receiving cavity, a product 500 may be securely suspended within container 200.

FIGS. 5A to 5D illustrate the utilization of a pair of product supports 10a, 10b in the packaging of a product 500 in container 200. As illustrated in FIG. 5A, first product support 10a and second product support 10b are placed over opposite ends of product 500 to receive opposite ends of product 500 in the product receiving cavities 40, one end in the product receiving cavity 40 of the first product support 10a and the other end in the product receiving cavity 40 of the second product support 10b. FIG. 5B illustrates the product 500 with ends received in the first product support 10a and the second product support 10b positioned within container 200 with container top 201 enclosing container 200. Note that container top 201 defines top inner wall 206. As positioned, the first peripheral edge 13 is peripherally in contact with the inner walls 202 of container 200. Thus, in the illustrated implementations, the first peripheral edge 13 functioning as the first engagement portion 43 for each of the illustrated product supports 10a, 10b contacts the entire internal rectangular cross section of container 200 including the front inner wall 212, bottom inner wall 204, back inner wall 214, and top inner wall 206. With the product support 10a positioned on the left side of container 200, second peripheral edge 15 functions as a second engagement portion 45 and extends across the length of container 200 along left inner wall 208 and second engagement portions 45 to contact a small portion of a length of the front inner wall 212 and a length of the back inner wall 214. With the other product support 10b positioned on the right side of container 200, the second peripheral edge 15 functions as a second engagement portion 45 and extends across the length of container 200 along the right inner wall 210 to contact a portion of the length of the front inner wall 212 and a portion of a length of the back inner wall 214. With the two product supports 10a, 10b each positioned at an end of container 200 and product 500 received in and abutting the portion of the second peripheral edge 15 of the second corrugated element 14 that defines the end of the product receiving cavity 40, product 500 may be securely suspended within container 200, as illustrated in FIG. 5B.

Exemplary configurations of corrugated fiberboard 140 that may be used to construct product support 10 in accordance with the present inventions are illustrated in more detail in FIGS. 6A to 6D and FIG. 7. A corrugated fiberboard 140 in the configuration of a single wall corrugated fiberboard 147 is illustrated in FIG. 6A. The exemplary single wall 147 corrugated fiberboard 140 is formed by securing a fluted medium 142 comprising flutes 170a, 170b, 170c between a first linerboard 144a and a second linerboard 144b. The flute tips 172a, 172c, 172e of the flutes 170a, 170b, 170c, respectively, are secured to the first linerboard 144a and the flute tips 172b, 172d, 172f of the flutes 170a, 170b, 170c, respectively, are secured to the second linerboard 144b in an alternating pattern, as illustrated.

A double wall 148 corrugated fiberboard 140 has a first fluted medium 142a secured between the first linerboard 144a and the second linerboard 144b, and a second fluted medium 142b secured between the second linerboard 144b and a third linerboard 144c, as illustrated in FIG. 6B. A triple wall 149 corrugated fiberboard 140 has first medium 142a secured between the first linerboard 144a and the second linerboard 144b, second medium 142b secured between the second linerboard 144b and the third linerboard 144c, and third medium 142c secured between the third linerboard 144c and a fourth linerboard 144d, as illustrated in FIG. 6C.

FIG. 6D illustrates an end view of an implementation of a single wall 147 corrugated fiberboard 140 with a fluted medium 142 as viewed from the open end 173 of the flutes 170a, 170b, 170c. As illustrated, the flutes 170a, 170b, 170c form a succession of arch shaped structures between the linerboards 144a, 144b. The fluted medium 142 is secured to the linerboards 144a, 144b generally at the flute tips 172a, 172b, 172c, 172d, 172e, 172f with alternating flute tips 172a, 172b, 172c, 172d, 172e, 172f secured to linerboard 144a and to linerboard 144b in succession. The gap between linerboard 144a and linerboard 144b generally corresponds to the chordal height 178 of the flutes 170a, 170b, 170c.

The corrugated fiberboard 140 may use starch-based adhesives to secure the one or more fluted medium 142 to the one or more adjacent linerboards 144. Starch-based adhesives may be recyclable, and, accordingly, may be advantageous in certain implementations. However, other adhesives may alternatively be used in place of starch-based adhesives in various other implementations, as would be readily recognized by those of ordinary skill in the art upon study of this disclosure.

As illustrated in FIG. 7, the above cited corrugated fiberboard 140 structures may be laminated together with an adhesive 110 coating to form first corrugated element 12, second corrugated element 14, and third corrugated element 16. For example, as illustrated in FIG. 7, laminate 100 is formed from two single wall 147 corrugated fiberboards 140a, 140b resulting in laminate 100 comprising first linerboard 144a, fluted medium 142, and second linerboard 144b of the first corrugated fiberboard 140a, a layer of adhesive 110 between the second linerboard 144b of first corrugated fiberboard 140a and a first linerboard 144a of the second corrugated fiberboard 140b, fluted medium 142, and the second linerboard 144b of the second corrugated fiberboard 140b. Similarly, combinations of single wall 147, double wall 148, and triple wall 149 may be laminated together using adhesive 110 in various combinations to form first corrugated element 12 and second corrugated element 14 having various structures of fluted medium 142 and linerboard, such as linerboard 144a, 144b, 144c, 144d. The materials of the various linerboards and fluted mediums may be either similar or dissimilar in laminate 100, in various implementations. Depending on the design requirements and materials used, the laminate 100 may be laminated from two to six layers of corrugated fiberboard 140, in some implementations. The corrugated fiberboard 140 may be die-cut into the shape of the first corrugated elements 12 and the second corrugated elements 14 before lamination, then superimposed upon one another after applying the layer of adhesive 110 between the second linerboard 144b and first linerboard 144a of adjacent corrugated fiberboards 140 and finally compressing the corrugated fiberboard 140 layers together as the adhesive 110 dries or cures to assure adequate bonding by adhesive 110. Alternatively, the laminate 100 may be formed by laminating adhesively full sheets of corrugated fiberboard 140 together followed by the cutting of the first corrugated elements 12, the second corrugated elements 14, and the third corrugated element 16 from laminate 100 after adhesive 110 has adequately dried or cured. Other configurations of laminate100 may also be used in the present inventions, as would be recognized by those of ordinary skill in the art upon study of this disclosure.

The specific type of corrugated fiberboard 140 may be chosen based upon the design requirements and cost effectiveness for packaging a particular product 500. Further, the orientation of the corrugated fiberboard 140 for a particular application of a product support 10 may be chosen based upon specific design requirements. The corrugated fiberboard 140 used typically includes two or more linerboards 144 and at least one fluted medium 142 with the two or more linerboards 144 interposed with one or more fluted mediums 142 to form the corrugated fiberboard 140. The linerboard 144 is usually a flat sheet of paper, and the fluted medium 142 is also a paper material configured in a series of flutes 170, in various implementations.

As illustrated in FIGS. 6A, 6B, 6C, 6D, flute 170 may define flute axis 176 and, accordingly, the series of flutes 170a, 170b, 170c in the fluted medium 142 form a series of parallel flute axes 176. Each flute 170 is typically configured as a column 182 about each flute axis 176, the flute axis 176 passing generally along the column length 184 of the column 182. The series of columns 182 into which the fluted medium 142 is configured may then define the load bearing axis 164 of the corrugated fiberboard 140 such that the corrugated fiberboard 140 may be more resistant to tensile or compressive forces (e.g., have maximum strength) along the load bearing axis 164. For corrugated fiberboard 140 with a fluted medium 142, the strongest load bearing axis 164 aligns with the flute axes 176, in various implementations.

Standard flute 170 designations such as A, B, C, E, and F are differentiated by a specific number of flutes 170 per unit length and the specific chordal heights 178. It will be appreciated that the fluted medium 142 strength along the load bearing axis 164 increases with flute density. The choice of flute density as well as the materials of fluted medium 142 and linerboard 144, and choice of adhesive 110 included in the corrugated fiberboard 140 will depend upon the specific design requirements including the loads to be resisted.

The corrugated fiberboard 140 may have any of a variety of configurations of flute materials 142 and linerboards 144. For example, the corrugated fiberboard 140 may single wall 147, double wall 148, or triple wall 149. In one implementation the corrugated fiberboard 140 may have a first linerboard 144a, first fluted material 142a, second linerboard 144b, second fluted material 142b, and a third linerboard 144c combination where all of the components are the same composition and weight or where each component is a different composition and weight or any iteration thereof. Further, the flute sizes may be different sizes and thicknesses in each layer of fluted material. The corrugated fiberboard 140 may also have other combinations of fluted material 142 and linerboard 144, as would be readily recognized by those of ordinary skill in the art upon study of this disclosure.

The foregoing discussion along with the Figures discloses and describes various exemplary implementations. These implementations are not meant to limit the scope of coverage, but, instead, to assist in understanding the context of the language used in this specification and in the claims. The Abstract is presented to meet requirements of 37 C.F.R. § 1.72(b) only. Accordingly, the Abstract is not intended to identify key elements of the apparatus and methods disclosed herein or to delineate the scope thereof. Upon study of this disclosure and the exemplary implementations herein, one of ordinary skill in the art may readily recognize that various changes, modifications and variations may be made thereto without departing from the spirit and scope of the inventions as defined in the following claims.

1. An apparatus for securing a product in packaging, comprising:
a first corrugated element 12 defining a first front side 23 of planar configuration and a first back side 33 of planar configuration oriented parallel to the first front side 23, a first peripheral edge 13 joins the first front side 23 with the first back side 33, the first peripheral edge 13 having a first engagement portion 43 configured to abut at least three inner walls 202 of a container 200, the first corrugated element 12 comprising at least two corrugated fiberboards 140 adhesively laminated together with flute axes 176 of the at least two corrugated fiberboards 140 of the first corrugated element 12 in parallel alignment;
a second corrugated element 14 securable to the first corrugated element 12, the second corrugated element 14 defining a second front side 25 of planar configuration and a second back side 35 of planar configuration oriented parallel to the second front side 25, a second peripheral edge 15 joins the second front side 25 with the second back side 35, the second peripheral edge 15 having a second engagement portion 45 configured to abut at least an inner wall 202 of the container 200, the second corrugated element 14 comprising at least two corrugated fiberboards 140 adhesively laminated together with flute axes 176 of the at least two corrugated fiberboards 140 of the second corrugated element 14 in parallel alignment;
a product receiving cavity 40 configured to receive a product 500, the product receiving cavity 40 comprises a passage 50 defined between the first front side 23 of the first corrugated element 12 and a first back side 33 of the first corrugated element 12 and a cavity end portion 60 defined by the second corrugated element 14; and
wherein the first corrugated element 12 and the second corrugated element 14 in securement to one another orient flute axes 176a of the first corrugated element 12 perpendicularly to flute axes 176b of the second corrugated element 14.

2-19. (canceled)
